(19) United States
(12) Patent Application Publication
(10) Pub. No.: US 2005/0053770 A1
(43) Pub. Date: Mar. 10, 2005

(54) Flat denim fabric (indigo) - in a serge or screen structure with threads of several compositions - printed on the reverse side for use in clothes

(76) Inventor: Claudia Yammine Boim, Sao Paulo (BR)

Correspondence Address: JACOBSON HOLMAN PLLC, 400 SEVENTH STREET N.W., SUITE 600, WASHINGTON, DC, 20004, US

(21) Appl. No.: 10/656,229

(22) Filed: Sep. 8, 2003

(51) Int. Cl. B32B 5/02; B32B 3/00; B32B 9/00

(52) U.S. Cl. 428/195.1; 428/196; 442/59; 442/65; 442/67

(57) ABSTRACT

A flat denim fabric (indigo) is described which has a traditional finish in the obverse side and prints on the reverse side, making possible the production of clothes that can be dressed either on its obverse side or on its reverse side, double-face, such a fabric being particularly suitable for pieces of garments, in addition to making possible differentiated laundry finishes on both sides.

The present invention refers to a flat denim fabric printed on the reverse side in a serge or screen structure with threads of several compositions—for use in clothes that can be used either on its external side as well as on its opposite side.

### DESCRIPTION OF THE STATE OF THE ART

The denim fabric used in making clothes, traditionally, possesses an usable side (obverse) while the opposite face is kept without finish, since that face is inside of the vestment, and therefore, not visible. The double-face clothes, which can be used both on one side or on the other, are already known of the state of the art, however they are usually made of two different fabrics sewn together; when using a flat denim fabric that, usually, it is a thick and heavy fabric, when yet another layer of fabric is sewn on that flat denim fabric in order to make the double-face vestment, there is an increase in the thickness and total weight of the clothes, leaving them uncomfortable and even inappropriate for use due to the strong rigidity of the fabric layers juxtaposed. In the specific case of the production of pants for normal wear where typically the thickness cannot be very large to guarantee the user's comfort, it becomes impracticable to use denim as a fabric for double-face clothes. Therefore, it is desirable the existence of a flat fabric of the denim type (indigo) to produce pieces of double-face clothes, making it possible to wear it in both faces, that it eliminates the problem of the thickness, weight and rigidity of the clothes and streamlines and reduces its cost as well as the production process.

### OBJECTIVE OF THE INVENTION

The objective of the present invention is to provide a flat denim fabric (indigo) for production of double-face clothes. Such an objective is reached through a denim fabric (indigo) which has a traditional finish in the obverse face and a print on the reverse side, making possible the production of lighter and practical double-face clothes

### SUMMARIZED DESCRIPTION OF THE DRAWINGS

The present invention will be more succinctly described below based on an example of processing represented in the drawings, that show:

FIG. 1—a perspective view of a portion of a flat denim fabric traditionally visible in its obverse side;

FIG. 2—a perspective view on the reverse side of the same portion of flat denim fabric printed for use in double-face clothes.

### DETAILED DESCRIPTION OF THE FIGURES AND OF THE INVENTION

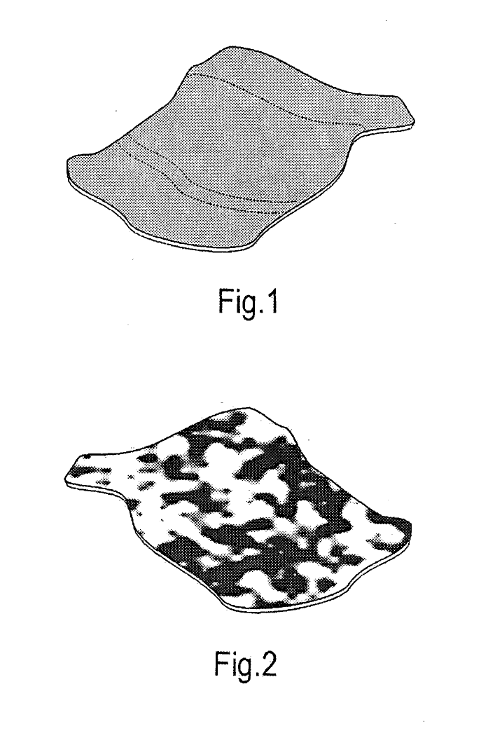

Referring to FIGS. 1 and 2, it can be noticed that the flat denim fabric possesses the additional indigo finish in the visible obverse face and a print in the reverse part, and therefore, the fabric presents beautiful visual aspect in both faces, allowing the production of clothes that can be dressed both on its obverse side as well as on its reverse double-face side.

Since the flat denim fabric of the invention, in itself, already has that finish for use in both faces, the production of the piece of double-face clothes is quite simplified. Therefore, there is no need that an extra layer of fabric is sewn on it; this reduces the thickness of the clothes, which become more malleable and comfortable, decreasing the total weight of the vestment.

Another innovation offered by the flat denim fabric of the invention it is the fact of also being able to be discolored and/or to receive different laundry finishes in both faces. The equivalent flat fabrics of the current technique, do not present this characteristic, because they allow laundry finish in one on the sides only, namely, the obverse side. Also, as a differential, the new fabric is suitable for a differentiated utilization in the same collection for which was originally acquired.

Likewise, the user/buyer of the clothes made with the fabric object of the invention benefits from the possibility of two different uses from the same garment.

Having been described an example of a main materialization, it should be understood that the scope of the present invention embraces other possible variations, thus, being only limited by the content of the claims herein, which includes all possible equivalents.

1. “FLAT DENIM FABRIC (INDIGO)—IN A SERGE OR SCREEN STRUCTURE WITH THREADS OF SEVERAL COMPOSITIONS—PRINTED ON THE REVERSE SIDE FOR USE IN CLOTHES”, characterized by the fact that the said flat denim or indigo fabric has a traditional finish on the obverse side and prints on the reverse face, making possible the production of garments that can be wore either on its obverse side or on its reverse side, double-face, with comfort and lightness.

2. “FLAT DENIM FABRIC (INDIGO)—IN A SERGE OR SCREEN STRUCTURE WITH THREADS OF SEVERAL COMPOSITIONS—PRINTED ON THE REVERSE SIDE FOR USE IN CLOTHES”, in agreement with claim 1, characterized by the fact of being particularly used in the production of clothes for general wear that can be used both on the obverse side as well as on the reverse side.

3. “FLAT DENIM FABRIC (INDIGO)—IN A SERGE OR SCREEN STRUCTURE WITH THREADS OF SEVERAL COMPOSITIONS—PRINTED ON THE REVERSE SIDE FOR USE IN CLOTHES” in agreement with claim 1, characterized by the fact of could receive differentiated laundry finishes in both faces.
